(19) United States
(12) Patent Application Publication
(10) Pub. No.: US 2026/0061436 A1
(43) Pub. Date: Mar. 5, 2026

(54) NOVEL SHOWER HEAD DEVICE

(71) Applicant: Wubin Liu, Macheng City (CN)

(72) Inventor: Wubin Liu, Macheng City (CN)

(21) Appl. No.: 19/310,543

(22) Filed: Aug. 26, 2025

(30) Foreign Application Priority Data
Aug. 28, 2024 (CN) 202422088611.8

(51) Int. Cl. B05B 1/18

(52) U.S. Cl. CPC B05B 1/182

(57) ABSTRACT

A novel shower head device includes: a handle assembly, where a water flow cavity is formed in the handle assembly, a tail of the handle assembly is used to be connected to a water pipe, a shower plate is detachably mounted at a head of the handle assembly, and a water spraying portion and a rubdown assembly are arranged on the shower plate at an interval; and at least one first through hole and at least one second through hole are provided in the shower plate, the rubdown assembly includes at least one tie and the at least one rubdown unit, and by sequentially passing the tie through the first through hole and a corresponding second through hole, and forming a tying space between the tie and the shower plate, the rubdown unit is at least partially confined in the tying space.

### CROSS REFERENCE TO RELATED APPLICATIONS

The present disclosure claims the priority of Chinese Patent Application No. 202422088611.8 filed on Aug. 28, 2024. All the above are hereby incorporated by reference in their entirety.

### TECHNICAL FIELD

The present disclosure relates to the technical field of bathroom ware, and in particular, to a novel shower head device.

### BACKGROUND

A shower head, also known as a showerhead, is a shower device that disperses water flow through a shower nozzle. It was originally a plant watering tool and was later improved into a common bathroom apparatus. The shower head includes a handheld shower head body equipped with a single shower nozzle and a hose. The handheld shower head body can be handheld to shower at will. With convenience and flexibility, it can be used easily to wash all parts of your body. With little space occupied, the shower head is suitable for various kinds of people.

However, the existing shower head can be merely used for ordinary bathing instead of rubdown. As a result, its convenience is reduced.

### SUMMARY

An objective of the present disclosure is to provide a novel shower head device in order to solve the technical problem that a shower head in the prior art can merely satisfy a common requirement for bath taking and cannot be used for rubdown.

In order to achieve the objective, a technical solution of the present disclosure provides a novel shower head device. The novel shower head device includes:
a handle assembly, where a water flow cavity is formed in the handle assembly, a tail of the handle assembly is used to be connected to a water pipe, a shower plate is detachably mounted at a head of the handle assembly, and a water spraying portion and a rubdown assembly are arranged on the shower plate at an interval; and
at least one first through hole and at least one second through hole are provided in the shower plate, the first through holes and the second through holes are arranged in one-to-one correspondence, the rubdown assembly includes at least one tie and at least one rubdown unit, and by sequentially passing the tie through the first through hole and a corresponding second through hole, and forming a tying space between the tie and the shower plate, the rubdown unit is at least partially confined in the tying space.

Further, the water spraying portion comprises a plurality of water outlets, and the water outlet and the rubdown unit are staggered.

Further, the rubdown assembly is mounted at a middle position of the shower plate, and the water spraying portion is arranged around the rubdown assembly.

Further, the water spraying portion is arranged at a middle position of the shower plate, and the rubdown assembly is arranged around the water spraying portion.

Further, the rubdown assemblies and the water spraying portions are alternately arranged one by one on the shower plate in a circumferential direction; and/or

the rubdown assemblies and the water spraying portions are alternately arranged on the shower plate in a radial direction.

Further, a shower gel hole is provided in the shower plate, and a shower gel chamber for containing a shower gel is provided in the handle assembly; the shower gel chamber communicates with the shower gel hole, and the shower gel chamber is provided with a pressing portion; and the pressing portion is mounted on the handle assembly, and by pressing the pressing portion, the shower gel in the shower gel chamber is pushed out of the shower gel chamber through the shower gel hole.

Further comprising a shower gel pipe, wherein a shower gel hole is provided in the shower plate, one end of the shower gel pipe communicates with an outlet of a shower gel bottle, and the other end of the shower gel pipe sequentially passes through the water pipe and the handle assembly and communicates with the shower gel hole, such that hot water in the water pipe is capable of preheating a shower gel in the shower gel pipe, and when a pressing pump is pressed, a shower gel in the shower gel bottle is capable of being pumped into the shower gel pipe, and the shower gel is pumped out through the shower gel hole.

Further, a middle position of the rubdown unit is tied with the tie, so as to form approximately sectoral rubdown areas at two ends of the rubdown unit; and/or

an edge position of the rubdown unit is tied with the tie, so as to form a fluffy rubdown area in a middle of the rubdown unit.

Further, the rubdown unit is a sponge, a hairbrush, a loofah sponge, a fiber, nylon, or a plastic foaming net bath flower.

The technical solution of the present disclosure provides a novel shower head device. The novel shower head device includes:
a handle assembly, where a water flow cavity is formed in the handle assembly, and a tail of the handle assembly is used to be connected to a water pipe; a shower plate is detachably mounted at a head of the handle assembly, and a water spraying portion and a rubdown assembly are arranged on the shower plate; and the water spraying portion includes a plurality of water outlets, and the water outlet and a rubdown unit are staggered;
at least one first through hole and at least one second through hole are provided in the shower plate, the first through holes and the second through holes are arranged in one-to-one correspondence, the rubdown assembly includes at least one tie and the at least one rubdown unit, and by sequentially passing the tie through the first through hole and a corresponding second through hole, and forming a tying space between the tie and the shower plate, the rubdown unit is at least partially confined in the tying space; and
a shower gel hole is provided in the shower plate, and a shower gel chamber for containing a shower gel is provided in the handle assembly; the shower gel chamber communicates with the shower gel hole, and the shower gel chamber is provided with a pressing portion; and the pressing portion is mounted on the handle assembly, and by pressing the pressing portion, the shower gel in the shower gel chamber is pushed out of the shower gel chamber through the shower gel hole.

Further, the rubdown assembly is mounted at a middle position of the shower plate, and the water spraying portion is arranged around the rubdown assembly.

Further, the water spraying portion is arranged at a middle position of the shower plate, and the rubdown assembly is arranged around the water spraying portion.

Further, the rubdown assemblies and the water spraying portions are alternately arranged one by one on the shower plate in a circumferential direction; and/or

the rubdown assemblies and the water spraying portions are alternately arranged on the shower plate in a radial direction.

Further, a middle position of the rubdown unit is tied with the tie, so as to form approximately sectoral rubdown areas at two ends of the rubdown unit; and/or

an edge position of the rubdown unit is tied with the tie, so as to form a fluffy rubdown area in a middle of the rubdown unit.

Further, the rubdown unit is a sponge, a hairbrush, a loofah sponge, a fiber, nylon, or a plastic foaming net bath flower.

Further, each of the rubdown units comprises a first rubdown head and a second rubdown head, a plurality of first rubdown heads are mounted at an outer surface of the shower plate at intervals in a circumferential direction, so as to form a rubdown inner circle area, a plurality of second rubdown heads are mounted at the outer surface of the shower plate at intervals in the circumferential direction, so as to form a rubdown outer circle area, and the rubdown inner circle area formed by the first rubdown heads is located near a center of the shower plate.

As can be seen from the technical solution, in the novel shower head device of the present disclosure, the rubdown unit is fixedly mounted on the shower plate through the tie, such that a user can have a rubdown while taking a bath. In addition, the water spraying portion and the rubdown assembly are mounted in a staggered manner, and a water spraying area and a rubdown area do not overlap with each other. Thus, blocking of a water flow due to blocking of the water outlet of the water spraying portion by the rubdown assembly is prevented, and influence on a shower effect of the user is further avoided. Water spraying smoothness and rubdown effectiveness do not interfere with each other. The user does not need to detach or attach rubdown cloth during the bath, and can perform the water spraying and the rubdown simultaneously or alternately. A shower process is simplified, time is reduced, and desirable experience of the user is achieved.

### BRIEF DESCRIPTION OF THE DRAWINGS

In order to illustrate the technical solution in embodiments of the present disclosure more clearly, the following briefly introduces accompanying drawings used in the description of the embodiments. Obviously, the accompanying drawings in the following description are only some embodiments of the present disclosure. Those of ordinary skill in the art can obtain other accompanying drawings from these accompanying drawings without any creative efforts.

FIG. 1 is a front view of a novel shower head device according to Example 1 of the present disclosure.

FIG. 2 is a perspective view from another view angle of the novel shower head device according to Example 1 of the present disclosure.

FIG. 3 is a front view of a rubdown assembly according to Example 1 of the present disclosure.

FIG. 4 is a perspective view from another view angle of the rubdown assembly according to Example 1 of the present disclosure.

FIG. 5 is a front view of a novel shower head device according to Example 2 of the present disclosure.

FIG. 6 is a perspective view from another view angle of the novel shower head device according to Example 2 of the present disclosure.

FIG. 7 is a front view of a rubdown assembly according to Example 2 of the present disclosure.

FIG. 8 is a perspective view from another view angle of the rubdown assembly according to Example 2 of the present disclosure.

FIG. 9 is a sectional view of a handle assembly according to Example 3 of the present disclosure.

FIG. 10 is a schematic diagram of a connection structure of a shower gel pipe according to Example 4 of the present disclosure.

The accompanying drawings include the following reference numerals:
100. handle assembly; 110. shower plate; 111. first through hole; 112. second through hole; 113. shower gel hole; 120. water spraying portion; 121. water outlet; 130. rubdown assembly; 131. tie; 132. rubdown unit; 140. shower gel chamber;
200. water pipe;
300. pressing portion;
400. shower gel pipe;
500. shower gel bottle; and
600. water heater.

### DETAILED DESCRIPTIONS OF THE EMBODIMENTS

In order to make those skilled in the art better understand the technical solution of the present disclosure, the technical solution in the embodiments of the present disclosure will be clearly and completely described below with reference to accompanying drawings in the embodiments of the present disclosure. Obviously, the described embodiments are only a part of the embodiments of the present disclosure, but not all of the embodiments. Based on the embodiments of the present disclosure, all other embodiments obtained by those skilled in the art without any creative efforts fall within the protection scope of the present disclosure.

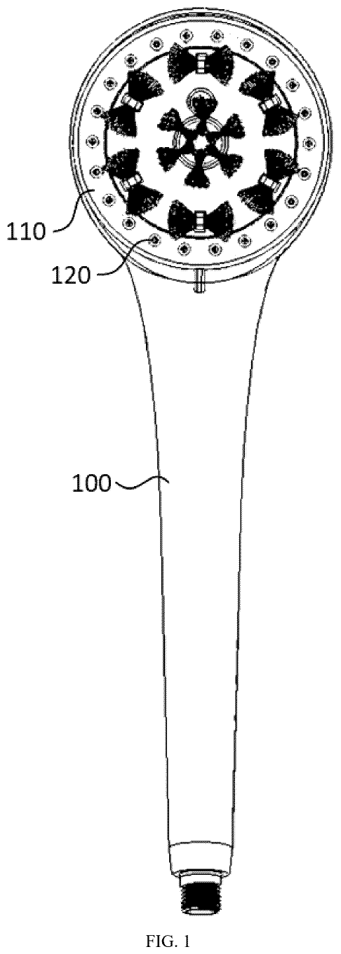

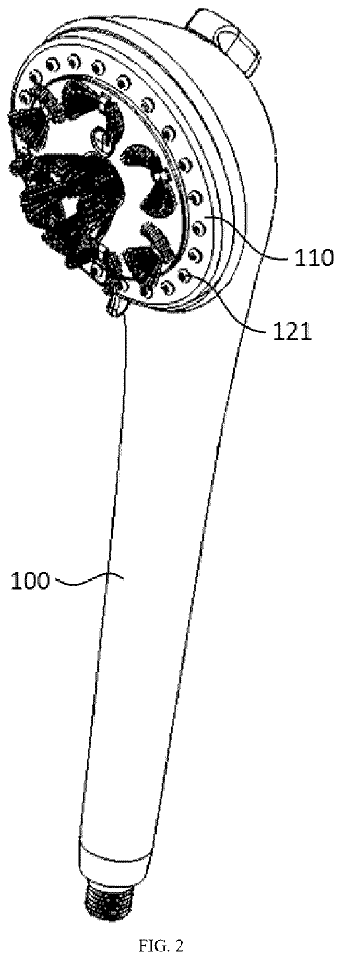

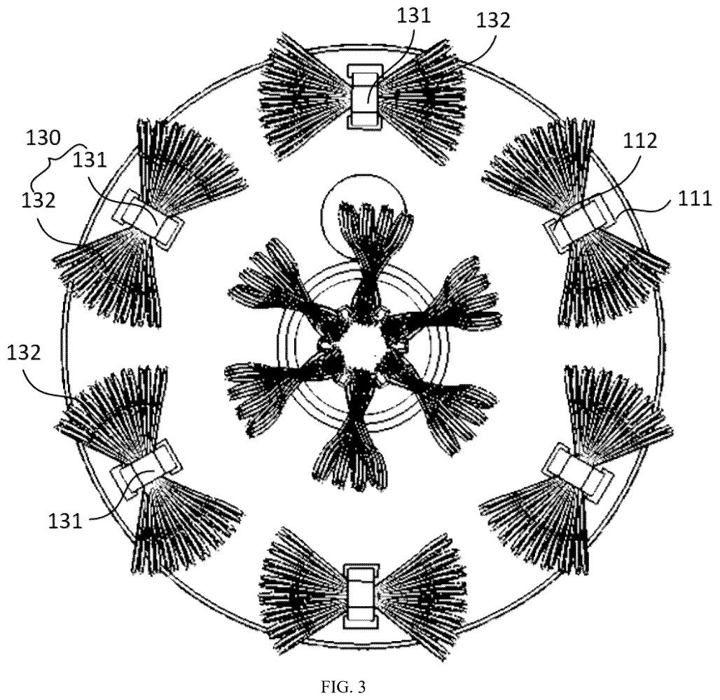

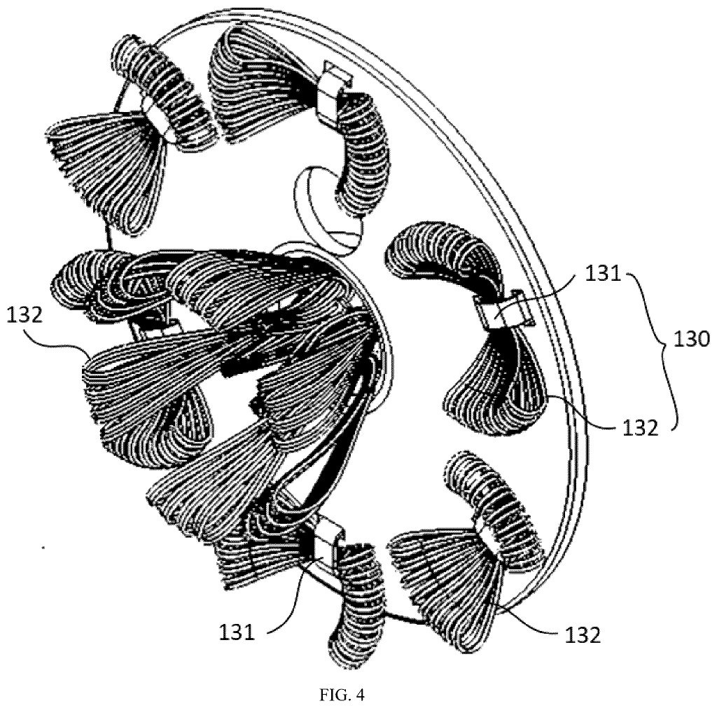

With reference to FIG. 1 to FIG. 4, in a first aspect, Example 1 provides a novel shower head device. The novel shower head device includes: a handle assembly 100. A water flow cavity is formed in the handle assembly 100, a tail of the handle assembly 100 is used to be connected to a water pipe 200, a shower plate 110 is detachably mounted at a head of the handle assembly 100, and a water spraying portion 120 and a rubdown assembly 130 are arranged on the shower plate 110 in a staggered manner. In this way, warm water in the water pipe 200 flows through the water flow cavity in the handle assembly 100 and the water spraying portion 120 in sequence and is sprayed outwards for a shower. At least one first through hole 111 and at least one second through hole 112 are provided in the shower plate 110, the first through holes 111 and the second through holes 112 are arranged in one-to-one correspondence, the rubdown assembly 130 includes at least one tie 131 and at least one rubdown unit 132, and by sequentially passing the tie 131 through the first through hole 111 and a corresponding second through hole 112, and forming a tying space between the tie 131 and the shower plate 110, the rubdown unit 132 is at least partially confined in the tying space.

It can be seen that in the novel shower head device of this example, the rubdown unit 132 is fixedly mounted on the shower plate 110 through the tie 131, such that a user can have a rubdown while taking a bath. In addition, the water spraying portion 120 and the rubdown assembly 130 are mounted in a staggered manner, and a water spraying area and a rubdown area do not overlap with each other. Thus, blocking of a water flow due to blocking of a water outlet 121 of the water spraying portion 120 by the rubdown assembly 130 is prevented, and influence on a shower effect of the user is further avoided. Water spraying smoothness and rubdown effectiveness do not interfere with each other. The user does not need to detach or attach rubdown cloth during the bath, and can perform the water spraying and the rubdown simultaneously or alternately. A shower process is simplified, time is reduced, and desirable experience of the user is achieved.

Further, the water spraying portion 120 includes a plurality of water outlets 121, and the water outlet 121 and the rubdown unit 132 are staggered. In this example, a diameter and a specific number of the water outlets 121 are not limited by the present disclosure as long as a water outflow rate of the water outlet 121 can reach a sufficiently high shower water flow rate. An end, farthest from the handle assembly 100, of the water pipe 200 communicates with a water heater 600.

In an example, the shower plate 110 is detachably connected to the head of the handle assembly 100 through a snap-in recess structure, and the snap-in recess structure may adopt the prior art, which is not repeated herein. Alternatively, in another example, a threaded column is arranged in the head of the handle assembly 100, and an internal threaded hole is provided in the threaded column. The shower plate 110 is provided with a threaded hole corresponding to the threaded column, and by screwing a bolt into the threaded column through the threaded hole, the shower plate 110 is mounted at the head of the handle assembly 100. Similarly, the shower plate 110 may be detached from the head of the handle assembly 100 by unscrewing the bolt. Preferably, two threaded columns are arranged, two threaded holes are provided, and the threaded columns and threaded holes are arranged in one-to-one correspondence, so as to mount the shower plate 110 at the head of the handle assembly 100. With such arrangement, influence on a rubdown effect due to accidental rotation of the shower plate 110 on the handle assembly 100 can be prevented, and desirable fixed mounting is implemented.

In this example, the rubdown unit 132 can be detachably mounted on the shower plate 110 through the tie 131. In this way, when the user needs to replace the rubdown unit 132 with a different type of rubdown unit, or clean the rubdown unit 132, or needs to replace the rubdown unit 132 with a new rubdown unit after long-term use, the entire rubdown assembly 130 can be detached and replaced by detaching the shower plate 110 on one hand. Such a detaching and replacement method is simple and efficient, and all rubdown units 132 are replaced in one step. On the other hand, by detaching the shower plate 110 and loosening the tie 131, the rubdown unit 132 can be replaced separately. In this way, the user can detach some of the rubdown units 132, and the user can clean the rubdown unit 132 separately. When some of the rubdown units 132 are aged after long-term use, some aged rubdown units 132 can also be replaced separately. Thus, maintenance cost is reduced.

In this example, the tie 131 is a self-locking nylon plastic tie in the prior art. In a possible embodiment, one side of the tie 131 is provided with a loop side of a hook and loop fastener, and the other side of the tie 131 is provided with a hook side of the hook and loop fastener. When the tie 131 is tied up, it is merely necessary to align and press the loop side of the hook and loop fastener and the hook side of the hook and loop fastener after the tie 131 is wound around the rubdown unit 132 for fixation. The operation is simple and intuitive. In addition, tightening of the tie 131 can be adjusted by opening the hook and loop fastener, such that the tie flexibly adapts to the rubdown units 132 of different thicknesses and hardness, and a fixation effect and integrity of the rubdown unit 132 are guaranteed. In another possible embodiment, two ends of the tie 131 are connected through a knot, to tie the rubdown unit 132. The knot is the prior art, and is not repeated herein.

In this example, as shown in FIG. 1 to FIG. 4, the rubdown assembly 130 is mounted at a middle position of the shower plate 110, and the water spraying portion 120 is arranged around the rubdown assembly 130. With such arrangement, a spatial layout of “central rubdown and peripheral water spraying” is formed, such that direct interference between the rubdown and water spraying is physically avoided. During the rubdown, the handle assembly 100 is handheld in one hand, the water spraying portion 120 does not prevent skin rubdown of the rubdown assembly 130, guaranteeing smooth rubdown action. During the water spraying, water flows are sprayed out from a circular structure, and can evenly cover a surrounding area of the rubdown assembly 130, and a main water flow path is not blocked by the rubdown assembly 130, thus guaranteeing integrity of a water spraying range. A step of detaching and attaching rubdown cloth by the user during a bath is omitted, the water spraying and the bathing can be seamlessly connected, an effect of simultaneous bathing and rubdown can be achieved, and convenience of the user is improved.

In a possible embodiment, the water spraying portion 120 is arranged at a middle position of the shower plate 110, and the rubdown assembly 130 is arranged around the water spraying portion 120. With such arrangement, a spatial layout of “central water spraying and peripheral rubdown” is formed, such that direct interference between the water spraying and the rubdown is physically avoided. With such arrangement, the step of detaching and attaching the rubdown cloth by the user during the bath can be omitted, the water spraying and the bathing can be seamlessly connected, the effect of simultaneous bathing and rubdown can be achieved, and the convenience of the user is improved.

In another possible embodiment, the rubdown assemblies 130 and the water spraying portions 120 are alternately arranged on the shower plate 110 in a circumferential direction. The rubdown assemblies 130 and the water spraying portions 120 are alternately arranged on the shower plate 110 in a radial direction. With such arrangement, a spatial layout of interpenetration of the water spraying portion 120 and the rubdown assembly 130 is formed, such that direct interference between the water spraying and the rubdown is physically avoided. With such arrangement, the step of detaching and attaching the rubdown cloth by the user during the bath can be omitted, the water spraying and the bathing can be seamlessly connected, the effect of simultaneous bathing and rubdown can be achieved, and the convenience of the user is improved.

In this example, as shown in FIG. 1 to FIG. 4, each of the rubdown units 132 includes a first rubdown head and a second rubdown head, a plurality of first rubdown heads are mounted at an outer surface of the shower plate 110 at intervals in a circumferential direction, so as to form a rubdown inner circle area, a plurality of second rubdown heads are mounted at the outer surface of the shower plate 110 at intervals in the circumferential direction, so as to form a rubdown outer circle area, and the rubdown inner circle area formed by the first rubdown heads is located near a center of the shower plate 110. The rubdown inner circle area is usually under more concentrated stress when in contact with the skin, has a smaller range, and is particularly suitable for small areas with thick corneocytes such as elbows and knees with stubborn dirt precisely removed. The outer circle area formed by the second rubdown heads is located near an edge of the shower plate 110, has wider coverage, is under more dispersed stress when in contact with the skin, and is especially suitable for large areas such as a back, legs, and an abdomen requiring efficient rubdown. A circumferential interval layout of the outer circle can enable the user to quickly cover a large area when rubdown, such that cleaning efficiency is improved.

In this example, a middle position of the rubdown unit 132 is tied with the tie 131, so as to form sectoral rubdown areas at two ends of the rubdown unit 132. The tie 131 and the rubdown unit 132 are elastic. After the middle of the rubdown unit 132 is tied with the tie 131, the two ends naturally expand outwards to form the sectoral areas. With such a form, the two ends of the rubdown unit 132 have a particular elastic deformation space, and the sectoral area can be naturally expanded, such that a contact area with the skin is expanded, and coverage of single time of rubdown is expanded.

In another embodiment, an edge position of the rubdown unit 132 is tied with the tie 131, so as to form a fluffy rubdown area in a middle of the rubdown unit 132. A plurality of connection ring structures are arranged at intervals at the edge position of the rubdown unit 132, and by sequentially passing the tie 131 through the first through hole 111, the connection ring structure, and the second through hole 112, the edge position of the rubdown unit 132 is mounted on the shower plate 110. With such arrangement, use comfortableness and durability are achieved, and replacement cheapness and convenience is further achieved.

In this example, the rubdown unit 132 is a sponge, a hairbrush, a loofah sponge, a fiber, nylon, or a plastic foaming net bath flower. The sponge has soft texture, strong water absorption, small friction and delicate touch when in contact with the skin, and has effects of gentle cleaning, moisturizing and buffering. The hairbrush rubs against the skin through dense bristles, and can thoroughly clear oil, dirt, and aged corneocytes from pores. The loofah sponge is a natural plant fiber, is tough in texture and has natural texture, can effectively exfoliate corneocytes when rubbing, and is milder than plastic material with particular water absorption and air permeability. The fiber material is usually delicate and soft, does not cause tingling sensation when in contact with the skin, and can reduce growth of bacteria. The nylon material has high hardness, high toughness, strong friction force, water resistance and wear resistance, and is not likely to deform or break after long-term use. A net structure of the forming net bath flower can be quickly combined with a shower gel to produce a large quantity of fine foam, the foam has strong adhesion, and direct rubbing on the skin during rubdown can be reduced through buoyancy of the foam. The user can flexibly replace the rubdown unit 132 made of different materials according to a frequency of use and wear and tear, so as to achieve the goal of selecting on demand and personalized cleaning.

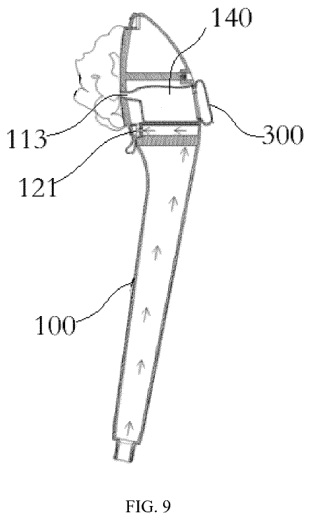

Example 3 provides a novel shower head device, as shown in FIG. 9. Different from Example 1, a shower gel hole 113 is provided in a shower plate 110, and a shower gel chamber 140 for containing a shower gel is provided in a handle assembly 100. A pressing portion 300 is further included. The pressing portion 300 is movably mounted on the handle assembly 100, and by pressing the pressing portion 300, the shower gel in the shower gel chamber 140 is pushed out of the shower gel chamber 140.

The shower gel hole 113 is provided in the shower plate 110, and the shower gel chamber 140 is arranged in the handle assembly 100. In this way, steps of separate obtaining and smearing the shower gel by a user during the shower are omitted. Without turning off the water flow or reaching for a shower gel bottle 500 placed elsewhere, the shower gel can be pushed out from the shower gel chamber 140 to the shower gel hole 113 through the pressing portion 300 slidably mounted on the handle assembly 100. The shower gel directly acts on a body, such that a shower process is simplified. In addition, the user can control pressing force according to demand and accurately adjust a squeezing amount of the shower gel. In addition, the shower gel chamber 140 is integrated in the handle assembly 100. In this way, compactness of an entire structure of the shower head is guaranteed, the shower gel can be further effectively protected, influence of external moisture on the shower gel is reduced, and storage time of the shower gel is prolonged. It should be noted that the pressing portion 300 is a silicone cover made of silicone, the shower gel can be added into the shower gel chamber 140 by removing the silicone cover, and space in the shower gel chamber 140 can be squeezed by pressing and deforming the pressing portion 300, such that the shower gel in the shower gel chamber 140 can be squeezed out through the shower gel hole 113. In order to prevent leakage when the shower gel is not used, a flexible plastic cover may cover the shower gel hole 113. When the shower gel is to be used, the flexible plastic cover may be opened at first and the pressing portion 300 is pressed. In addition, since the shower gel hole 113 and the flexible plastic cover are small, in order to prevent the flexible plastic cover from being lost, the flexible plastic cover may be connected to the shower plate 110 through a strip. In some other examples, a rubber seal is arranged at the shower gel hole 113, and a cross-shaped gap is provided in the rubber seal. In this way, when the pressing portion 300 is pressed, the rubber seal is deformed to communicate with the shower gel hole 113, and the shower gel can be squeezed out. When the pressing portion 300 is released, the rubber seal is reset to close the shower gel hole 113, such that the shower gel basically does not leak when the pressing portion 300 is not pressed.

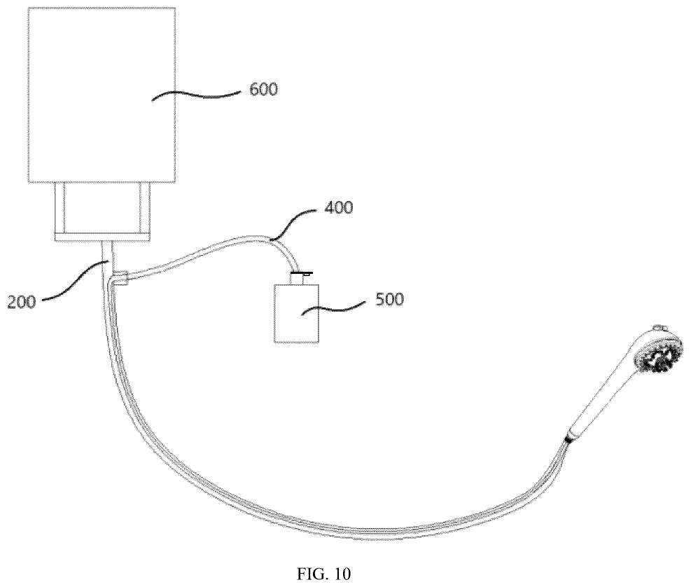

Example 4 provides a novel shower head device, as shown in FIG. 10. Different from Example 3, the novel shower head device further includes a shower gel pipe 400. A shower gel hole 113 is provided in a shower plate 110, one end of the shower gel pipe 400 communicates with an outlet of a shower gel bottle 500, and the other end of the shower gel pipe 400 sequentially passes through a water pipe 200 and a handle assembly 100 and communicates with the shower gel hole 113, such that hot water in the water pipe 200 is capable of preheating a shower gel in the shower gel pipe 400, and when a pressing pump is pressed, a shower gel in the shower gel bottle 500 is capable of being pumped into the shower gel pipe 400, and the shower gel is pumped out through the shower gel hole 113. The pressing pump is a spring pressing pump commonly used on a bottle cover of an existing shower gel bottle 500. The pressing pump is the prior art, and a specific structure of the pressing pump is not repeated herein. An end of the shower gel pipe 400 communicates with an outlet of the pressing pump at a mouth of the shower gel bottle 500.

Compared with the flexible silicone pressing portion 300 in Example 3, in Example 4, a large-capacity shower gel bottle 500 can be placed independently, limitation to a capacity of the shower gel chamber 140 by a size of the handle assembly 100 is avoided, and inconvenience of frequent filling of the built-in shower gel chamber 140 is solved. The shower gel pipe 400 passes through the water pipe 200 and communicates with the shower gel hole 113. With such arrangement, the hot water in the water pipe 200 is wrapped around the shower gel pipe 400, the shower gel is preheated, stimulation caused by contact of a low-temperature liquid with the skin in winter is reduced, and the bathing experience in cold areas can be especially improved. It should be noted that this example is an optional example. Due to a length of the shower gel pipe 400, large force is usually needed to press the spring pressing pump for pumping out the shower gel. If use by a user is limited, another example can be selected.

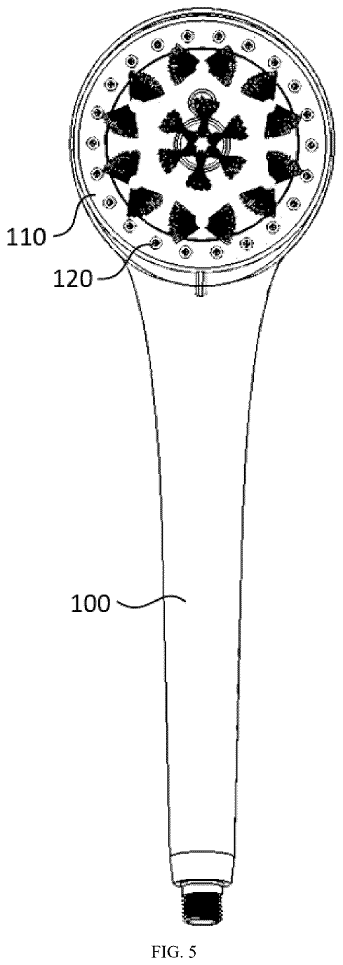

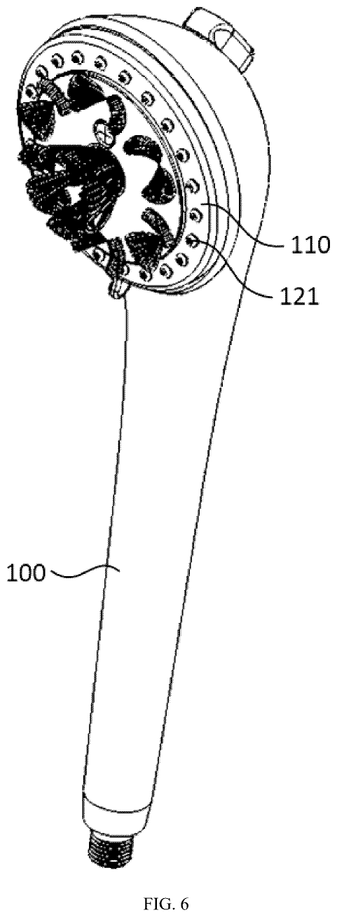

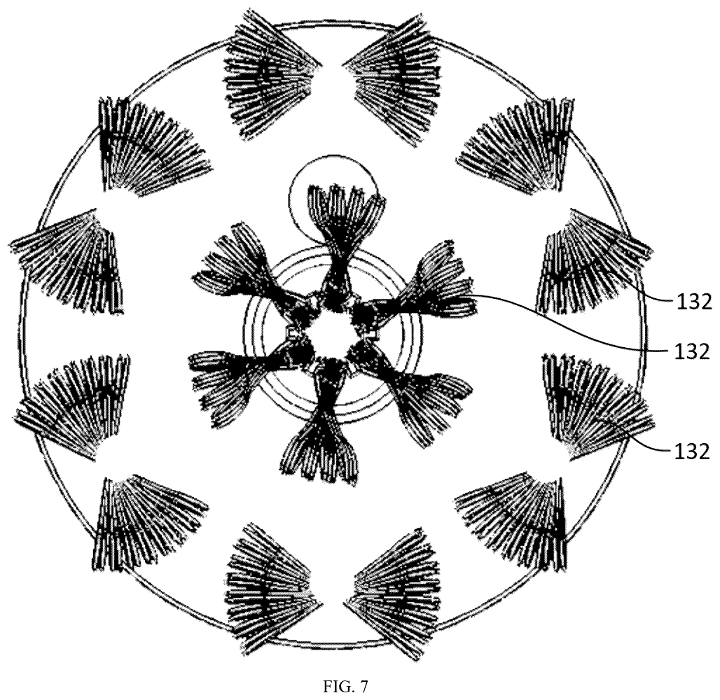

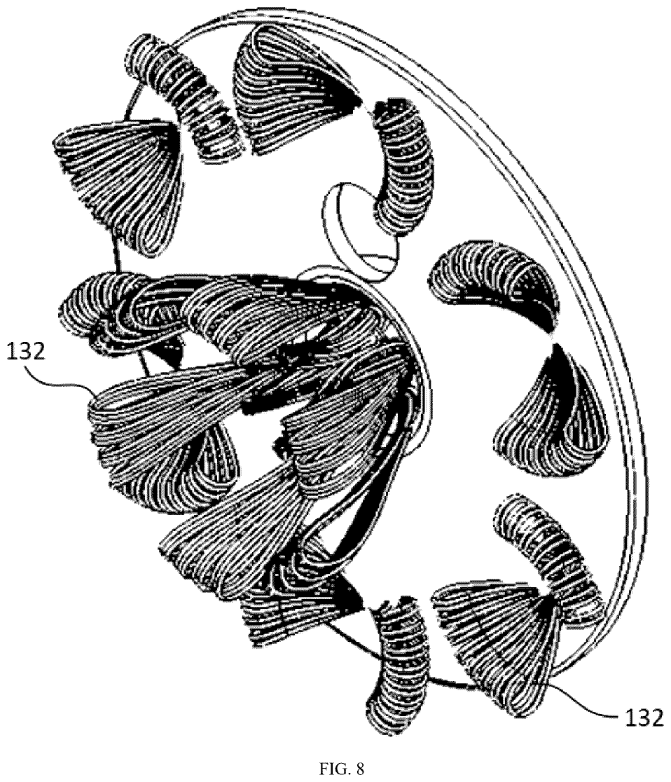

In addition, as shown in FIG. 5 to FIG. 8, Example 4 further provides the novel shower head device. The novel shower head device includes the handle assembly 100. A tail of the handle assembly 100 is used to be connected to the water pipe 200, the shower plate 110 is detachably mounted at a head of the handle assembly 100, and a water spraying portion 120 and a rubdown assembly 130 are arranged on the shower plate 110 in a staggered manner. The rubdown assembly 130 includes at least one rubdown unit 132. The rubdown unit 132 is at least partially embedded in the shower plate 110. The rubdown unit 132 and the shower plate 110 are formed into an integral structure through injection molding during production, such that the rubdown unit 132 is fixed to the shower plate 110.

The water spraying portion 120 and the rubdown assembly 130 are mounted in a staggered manner, and a water spraying area and a rubdown area do not overlap with each other. Thus, blocking of a water flow due to blocking of a water outlet 121 of the water spraying portion 120 by the rubdown assembly 130 is prevented. Water spraying smoothness and rubdown effectiveness do not interfere with each other. The user does not need to change tools during a bath, and can perform the water spraying and rubdown simultaneously or alternately. By detaching the shower plate 110, the entire rubdown assembly 130 can be detached and replaced. Such a detaching and replacement method is simple and efficient, and all rubdown units 132 are replaced in one step. The user detaches and replaces the rubdown unit 132 conveniently, and desirable use experience of the user is achieved.

It should be understood that when an element is referred to as being “on” or “connected to” another element, it can be directly on the other element or directly connected to the other element or indirectly connected to the other element by an intervening element therebetween. On the contrary, when an element is referred to as being “directly on” or “directly connected to” another element, there are no intervening elements therebetween. Also, it should be noted that if directional indications (such as up, down, left, right, front, back, etc.) are involved in the embodiment of the present disclosure, the directional indications are only used to explain a relative position relationship, a movement condition and the like between various components under a certain posture (as shown in the accompanying drawings). If the specific posture changes, the directional indication changes accordingly.

The above are the preferred embodiments of the present disclosure. It should be noted that those skilled in the art can make several improvements and modifications without departing from the principles of the present disclosure, and these improvements and modifications may be regarded as the protection scope of the present disclosure.

What is claimed is:

1. A novel shower head device, comprising:
a handle assembly, wherein a water flow cavity is formed in the handle assembly, a tail of the handle assembly is used to be connected to a water pipe, a shower plate is detachably mounted at a head of the handle assembly, and a water spraying portion and a rubdown assembly are arranged on the shower plate at an interval; and
at least one first through hole and at least one second through hole are provided in the shower plate, the first through holes and the second through holes are arranged in one-to-one correspondence, the rubdown assembly comprises at least one tie and at least one rubdown unit, and by sequentially passing the tie through the first through hole and a corresponding second through hole, and forming a tying space between the tie and the shower plate, the rubdown unit is at least partially confined in the tying space.

2. The novel shower head device according to claim 1, wherein the water spraying portion comprises a plurality of water outlets, and the water outlet and the rubdown unit are staggered.

3. The novel shower head device according to claim 1, wherein the rubdown assembly is mounted at a middle position of the shower plate, and the water spraying portion is arranged around the rubdown assembly.

4. The novel shower head device according to claim 1, wherein the water spraying portion is arranged at a middle position of the shower plate, and the rubdown assembly is arranged around the water spraying portion.

5. The novel shower head device according to claim 1, wherein the rubdown assemblies and the water spraying portions are alternately arranged one by one on the shower plate in a circumferential direction; and/or
the rubdown assemblies and the water spraying portions are alternately arranged on the shower plate in a radial direction.

6. The novel shower head device according to claim 1, wherein a shower gel hole is provided in the shower plate, and a shower gel chamber for containing a shower gel is provided in the handle assembly; the shower gel chamber communicates with the shower gel hole, and the shower gel chamber is provided with a pressing portion; and the pressing portion is mounted on the handle assembly, and by pressing the pressing portion, the shower gel in the shower gel chamber is pushed out of the shower gel chamber through the shower gel hole.

7. The novel shower head device according to claim 1, further comprising a shower gel pipe, wherein a shower gel hole is provided in the shower plate, one end of the shower gel pipe communicates with an outlet of a shower gel bottle, and the other end of the shower gel pipe sequentially passes through the water pipe and the handle assembly and communicates with the shower gel hole, such that hot water in the water pipe is capable of preheating a shower gel in the shower gel pipe, and when a pressing pump is pressed, a shower gel in the shower gel bottle is capable of being pumped into the shower gel pipe, and the shower gel is pumped out through the shower gel hole.

8. The novel shower head device according to claim 1, wherein a middle position of the rubdown unit is tied with the tie, so as to form approximately sectoral rubdown areas at two ends of the rubdown unit; and/or
an edge position of the rubdown unit is tied with the tie, so as to form a fluffy rubdown area in a middle of the rubdown unit.

9. The novel shower head device according to claim 1, wherein the rubdown unit is a sponge, a hairbrush, a loofah sponge, a fiber, nylon, or a plastic foaming net bath flower.

10. A novel shower head device, comprising:
a handle assembly, wherein a water flow cavity is formed in the handle assembly, and a tail of the handle assembly is used to be connected to a water pipe; a shower plate is detachably mounted at a head of the handle assembly, and a water spraying portion and a rubdown assembly are arranged on the shower plate; and the water spraying portion comprises a plurality of water outlets, and the water outlet and a rubdown unit are staggered;
at least one first through hole and at least one second through hole are provided in the shower plate, the first through holes and the second through holes are arranged in one-to-one correspondence, the rubdown assembly comprises at least one tie and the at least one rubdown unit, and by sequentially passing the tie through the first through hole and a corresponding second through hole, and forming a tying space between the tie and the shower plate, the rubdown unit is at least partially confined in the tying space; and
a shower gel hole is provided in the shower plate, and a shower gel chamber for containing a shower gel is provided in the handle assembly; the shower gel chamber communicates with the shower gel hole, and the shower gel chamber is provided with a pressing portion; and the pressing portion is mounted on the handle assembly, and by pressing the pressing portion, the shower gel in the shower gel chamber is pushed out of the shower gel chamber through the shower gel hole.

11. The novel shower head device according to claim 10, wherein the rubdown assembly is mounted at a middle position of the shower plate, and the water spraying portion is arranged around the rubdown assembly.

12. The novel shower head device according to claim 10, wherein the water spraying portion is arranged at a middle position of the shower plate, and the rubdown assembly is arranged around the water spraying portion.

13. The novel shower head device according to claim 10, wherein the rubdown assemblies and the water spraying portions are alternately arranged one by one on the shower plate in a circumferential direction; and/or
the rubdown assemblies and the water spraying portions are alternately arranged on the shower plate in a radial direction.

14. The novel shower head device according to claim 10, wherein a middle position of the rubdown unit is tied with the tie, so as to form approximately sectoral rubdown areas at two ends of the rubdown unit; and/or
an edge position of the rubdown unit is tied with the tie, so as to form a fluffy rubdown area in a middle of the rubdown unit.

15. The novel shower head device according to claim 10, wherein the rubdown unit is a sponge, a hairbrush, a loofah sponge, a fiber, nylon, or a plastic foaming net bath flower.

16. The novel shower head device according to claim 10, wherein each of the rubdown units comprises a first rubdown head and a second rubdown head, a plurality of first rubdown heads are mounted at an outer surface of the shower plate at intervals in a circumferential direction, so as to form a rubdown inner circle area, a plurality of second rubdown heads are mounted at the outer surface of the shower plate at intervals in the circumferential direction, so as to form a rubdown outer circle area, and the rubdown inner circle area formed by the first rubdown heads is located near a center of the shower plate.
